(19) United States
(12) Patent Application Publication
(10) Pub. No.: US 2010/0259458 A1
(43) Pub. Date: Oct. 14, 2010

(54) DUAL-ANGLE ADJUSTMENT OF A SATELLITE-TRACKING ANTENNA WITH A SINGLE MOTOR

(75) Inventors: Eric S. Mattis, San Diego, CA (US); Thomas J. Benacka, Solana Beach, CA (US); Bin Tian, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/423,620

(22) Filed: Apr. 14, 2009

(51) Int. Cl. H01Q 3/00

(52) U.S. Cl. 343/766

(57) ABSTRACT

An apparatus includes an azimuth adjuster coupled between a motor and a directional antenna. Motor rotation causes the azimuth adjuster to rotate the antenna about an azimuthal axis. The motor rotation also causes an elevation adjuster to rotate, which causes a screw mechanism to modify an elevation angle by pivoting the antenna about an elevational axis. To aim the directional antenna, a body-direction vector of a movable body with the antenna attached thereto is determined. Based on an elevational relationship between the body-direction vector and a satellite-direction vector, the elevation adjuster modifies the elevation angle of the antenna by rotating the motor to achieve full-turn amounts to pivot the antenna. The azimuth adjuster modifies an azimuth angle of the antenna based on an azimuthal relationship between the body-direction vector and the satellite-direction vector by rotating the motor to achieve partial-turn amounts of the antenna.

### BACKGROUND

Recently, directional antennas for communication with one or more satellites have been mounted on vehicles. A directional antenna has a relatively narrow beam and, therefore, must be pointed with relatively high precision at the satellite. Combining a pointing feature on a moving vehicle creates problems with multiple degrees of freedom.

Conventionally, electric motors attached to a gimbal have been used, for instance, to rotate antenna platforms such that the azimuth angle of the antenna is properly aligned with the satellite. Some antenna platforms may include an antenna with a wide enough elevation beam that the platform may be able to be configured with a fixed-look elevation angle. However, even with these wide elevation beams, some elevation angle adjustments may be needed if the antenna is to be placed in very different latitudes. In addition, any deviation from optimal elevation pointing will impact antenna performance.

With moving vehicles, that can cover a variety of latitudes and elevations, adjusting the azimuth angle is typically not sufficient. The elevation angle also must be adjusted. An additional motor attached to an additional gimbal for adjusting the elevation angle has been used conventionally. However, using multiple motors means more complexity and additional cost.

There is a need for systems, methods, and apparatuses for dual-angle adjustments of a satellite-tracking antenna that use only a single motor to accomplish both azimuth angle adjustments and elevation angle adjustments.

### BRIEF DESCRIPTION OF THE DRAWINGS

FIGS. 1A and 1B show a satellite and a movable body with a satellite-tracking antenna mounted thereon.

FIG. 2 shows an embodiment of an antenna aiming apparatus with a single motor and a front gear for an elevation adjuster.

FIG. 3 shows an exploded view of some of the elements of the antenna aiming apparatus shown in FIG. 2.

FIGS. 4A and 4B show upper and lower views of another embodiment of an antenna aiming apparatus with a single motor and a bevel gear as part of an elevation adjuster.

FIG. 5 is a simplified block diagram of an antenna aiming system.

FIG. 6 is a simplified flow chart of a method for aiming an antenna at a satellite when the antenna is attached to a movable body.

FIG. 7 is a graph of elevation angle relative to number of motor turns for various embodiments of the present invention.

FIGS. 8A and 8B show upper and lower views of another embodiment of an antenna aiming apparatus with a single motor and decoupled elevation and azimuth adjustments.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

Exemplary embodiments of the present invention are directed to systems, methods, and apparatuses for dual-angle adjustments of a satellite-tracking antenna that use only a single motor. With a single motor, embodiments of the present invention can still accomplish both azimuth angle adjustments and elevation angle adjustments.

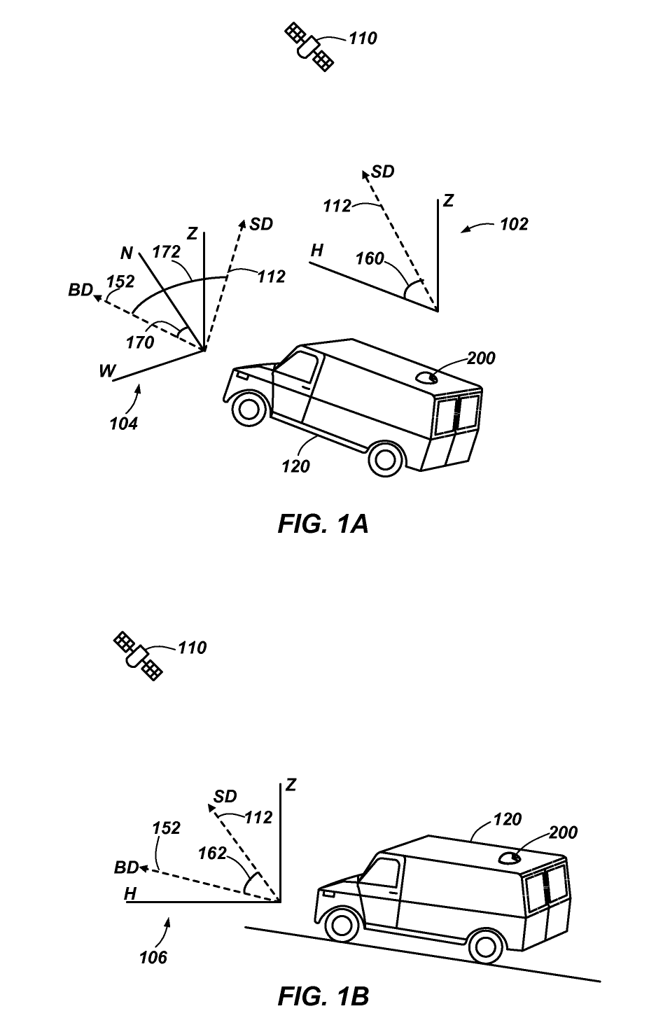

FIGS. 1A and 1B show a satellite 110 and a movable body 120 with a satellite-tracking antenna 200 mounted thereon. Coordinate systems are shown in FIGS. 1A and 1B to assist in description and show directional vectors used in describing exemplary embodiments of the present invention.

A movable body 120, as used herein, may include any type of body that is transportable. Some non-limiting examples are vehicles, boats, airplanes. In addition, a bracket or other mounting hardware to which the satellite-tracking antenna 200 is mounted for the purpose of mounting on a fixed object may be considered a movable body 120. For ease of description, for the most part, the movable body 120 may be referred to herein as a vehicle 120. However, those of ordinary skill in the art will recognize that the movable body may be stationary. Furthermore, adjustments made to the pointing of the antenna may be made simply to point to a satellite when the movable body is stationary or to point to additional satellites.

In FIG. 1A, a first coordinate system 102 shows a horizontal axis H (i.e., horizontal with the earth's surface) and a vertical axis Z. A second coordinate system 104 shows the vertical axis Z, a north axis N, and a west axis W. Thus, in FIG. 1A, the vehicle 120 is pointed in a somewhat northwest direction along level ground, as indicated by a body-direction vector 152. A satellite-direction vector 112 indicates a direction from the current geographic location of the vehicle 120 to the satellite 110. An elevation angle 160 shows an angle between the horizontal axis H and the satellite-direction vector 112.

Also shown in the second coordinate system 104 is an azimuth angle 170, which defines the angle between a north direction and the body-direction vector 152. An azimuthal relationship 172 is the angle between the current body-direction vector 152 and the satellite-direction vector 112 in a plane that is parallel with the horizontal axis H. Thus, as the vehicle 120 moves, the satellite-direction vector 112, the body-direction vector 152, and the azimuthal relationship 172 therebetween will change.

In FIG. 1B, a third coordinate system 106 shows the vertical axis Z, the horizontal axis H, the body-direction vector 152, and the satellite-direction vector 112. Thus, in FIG. 1B, the vehicle 120 is pointed somewhat upward relative to the horizontal axis H. An elevational relationship 162 is shown as the angle between the body-direction vector 152 and the satellite-direction vector 112 in a plane that is parallel with the vertical axis Z. Thus, as the vehicle 120 changes in elevation or points upward or downward relative to the horizontal axis, the satellite-direction vector 112, the body-direction vector 152, the elevation relationship 162, and the azimuthal relationship 172 will change.

The satellite-direction vector 112, body-direction vector 152, elevation angle 160, and azimuth angle 170 have been defined relative to a geographic location and a fixed coordinate system. However, those of ordinary skill in the art will recognize that for embodiments of the present invention these vectors and angles may be defined in other fixed coordinate systems. Specifically, a moving coordinate system relative to the vehicle 120 may be used.

As the vehicle 120 moves, the satellite tracking antenna 200 attached to the vehicle must adjust the direction it points to remain pointed at the satellite 110.

The embodiments described herein are described with respect to an electric motor, commonly used to rotate antenna platforms. However, it should be understood that the motor could alternatively comprise any type of motor, including those driven by means other than electrical signals. In addition, the embodiments described herein may be used in applications other than antenna assemblies, such as in automotive applications, and computer applications.

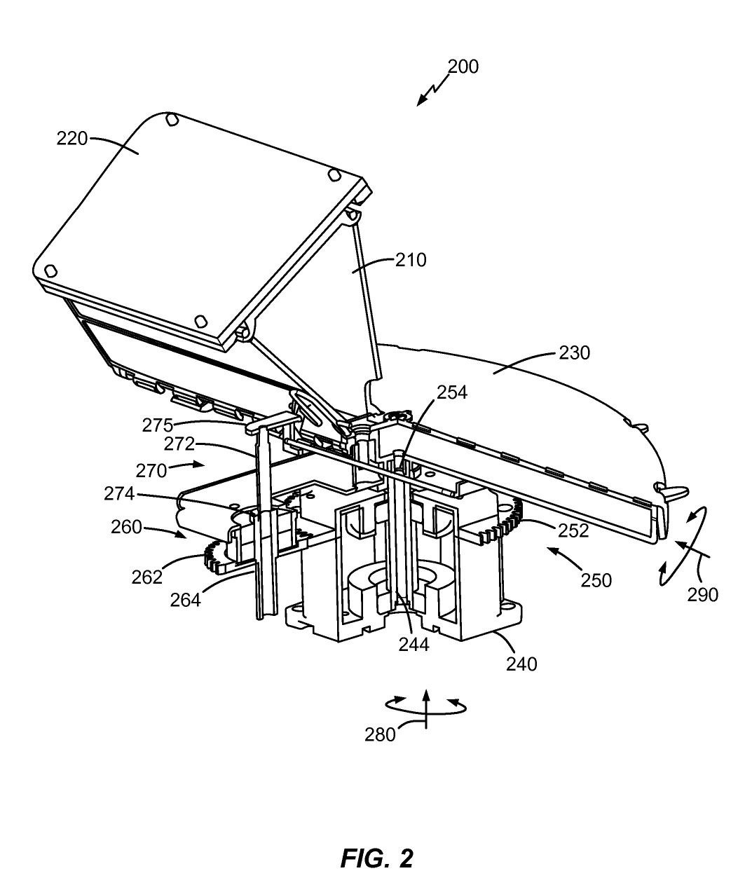

FIG. 2 shows an isometric, cutaway view, of an embodiment of an antenna aiming apparatus 200 (also referred to herein as the satellite-tracking antenna 200) with a single motor 240. The antenna aiming apparatus 200 includes a directional antenna aperture 210 (also referred to herein as a directional antenna), a faceplate 220 (which may include a circular polarizer), an antenna feed 230, an azimuth adjuster 250, and an elevation adjuster 260. Rotation of the shaft of motor 240 causes the azimuth adjuster 250 to rotate the directional antenna 210 through a full 360 degrees about an azimuthal axis 280 to point the antenna with the desired azimuthal angle 170 (FIG. 1). In addition, rotation of the motor also causes the elevation adjuster 260 to pivot the directional antenna 210 about an elevational axis 290 to point the antenna with the desired elevational relationship 162 (FIG. 1).

In FIG. 2, the azimuth adjuster 250 directly links a motor spindle 254 to the directional antenna 210. Thus, as the motor turns, the directional antenna 210 turns about the azimuthal axis. In other embodiments, the azimuth adjuster may include conveyors linking the motor spindle 244 to an azimuth spindle 254 on the directional antenna 210.

The term conveyor, as used herein, may include elements for coupling rotational motions between two spindles, such as, for example, belts, chains, and engaged gears.

The elevation adjuster 260 includes an elevation spindle 264 at the center of an elevation gear 262. The elevation gear is engaged with a first gear 252, which is fixedly attached to the motor housing. Of course, the first gear may be attached to any suitable fixed portion of the antenna aiming apparatus 200.

A screw mechanism 270 is attached to the elevation spindle 264. The screw mechanism 270 includes a lead nut 274 attached to the elevation spindle 264 and a lead screw 272 threaded through the lead nut 274. The lead screw 272 is attached to a linkage 275, which is attached to the directional antenna 210.

Thus, as the elevation gear 262 turns, so does the lead nut 274, which drives the lead screw 272 up or down depending on the direction of rotation for the elevation gear 262. As the lead screw 272 moves up, it pushes the directional antenna 210 up through the linkage 275. Similarly, as the lead screw 272 moves down, it pulls the directional antenna 210 down through the linkage 275.

A spring (not shown) may force the lead screw 272 against the lead nut 274 to allow the mechanism to over travel in both the up extreme and down extreme without locking up. When at an extreme, the lead screw 272 threads disengage and the minor diameter of the lead screw 272 contacts the threads of the lead nut 274.

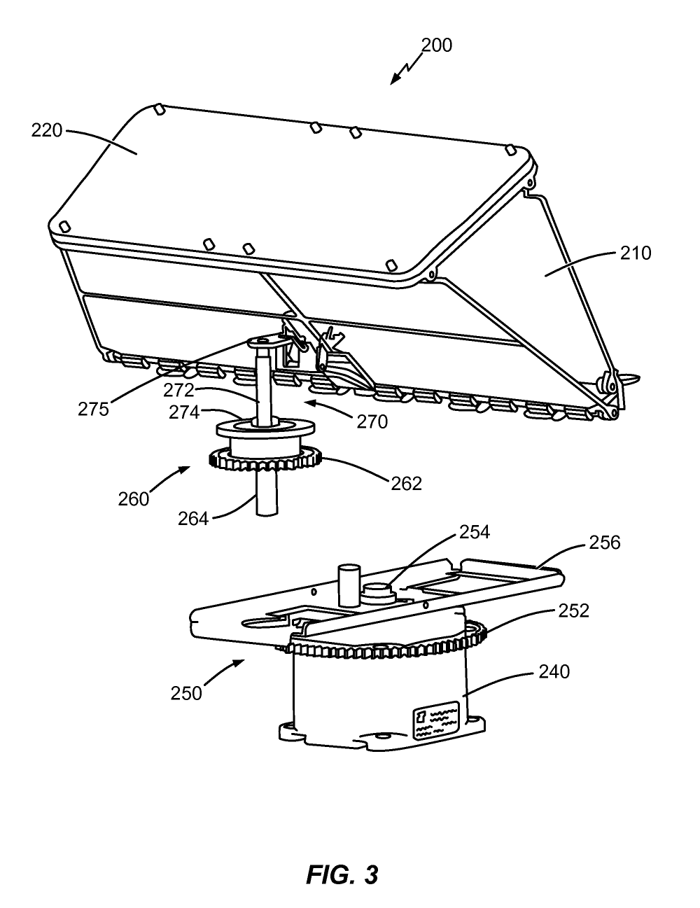

FIG. 3 shows an isometric, exploded view, of the antenna aiming apparatus 200 of FIG. 2. The elevation adjuster 260, screw mechanism 270, and antenna 210 are shown connected. In addition, the motor 240 is shown connected to the first gear 252 and a platform 256 for holding the directional antenna 210. In the FIG. 3 embodiment, the azimuth adjuster 250 and first gear 252 are shown disengaged from the elevation adjuster 260 with the elevation gear 262 and elevation spindle 264.

Referring to FIGS. 2 and 3, narrow beam, high gain antennas, need to be pointed relatively accurately at the satellite. With the directional antenna 210 used in exemplary embodiments of the present invention, there may be more tolerance to errors in elevation than in azimuth. Thus, exemplary embodiment of FIGS. 2 and can make very fine adjustments about the azimuthal axis 280 and relatively less fine adjustments about the elevational axis 290. Of course, other embodiments may provide finer adjustments in elevation relative to azimuth depending on gear (or other conveyor) ratios.

In operation, as the motor 240 turns, it turns the platform 256, and the directional antenna 210 about the azimuthal axis 280 and the stationary first gear 252. In addition, because the elevational gear 262 is engaged with the first gear 252, the elevational gear 262 will also turn as it orbits about the first gear 252. Rotation of the elevational gear 262 causes the lead screw 272 to turn, which pivots the directional antenna 210 about the elevational axis. Thus, a complete turn of the directional antenna 210 about the azimuthal axis 280 causes a small pivot up or down of the directional antenna 210 about the elevational axis 290, while also enabling the directional antenna 210 to point at any azimuth angle within the complete turn. Thus the azimuth adjustment and the elevation adjustment are coupled together and based on rotation amounts of a single motor. A more detailed explanation of pointing the directional antenna 210 is given below.

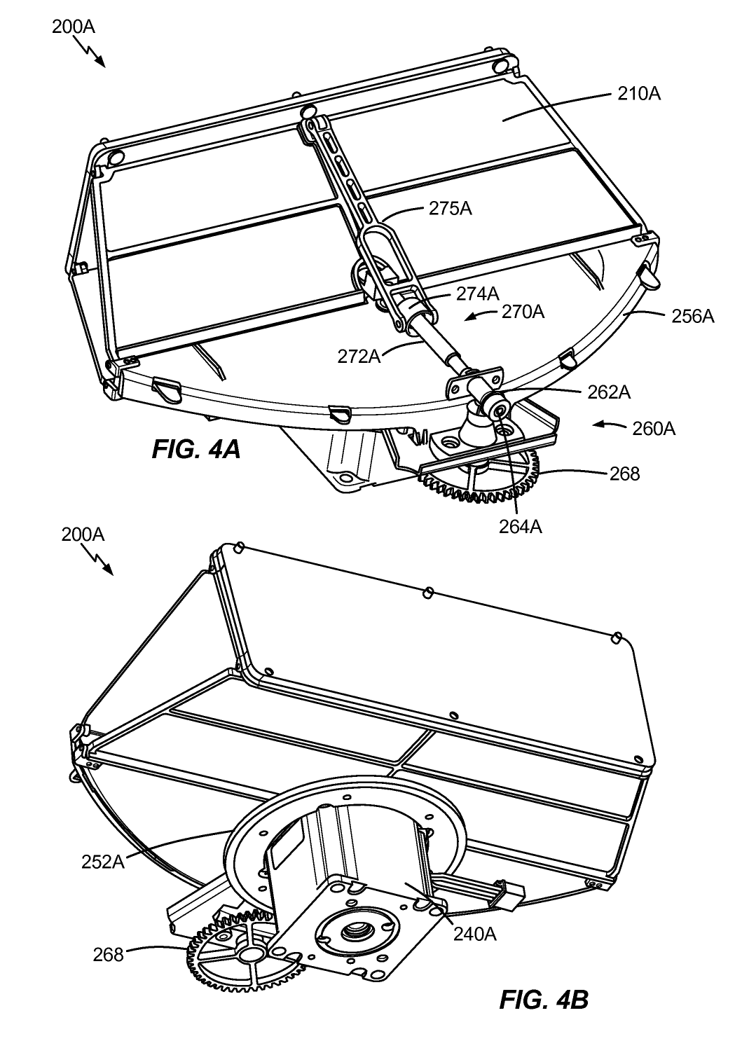

The exemplary embodiment of FIGS. 2 and 3 uses a first gear (e.g., a stationary azimuthal gear) engaged with a second gear (e.g., an elevational gear) to create the motion needed to point the directional antenna 210 using a single motor 240. However, engaged gears need not be used in some embodiments of the present invention. Other types of conveyors may be used to translate the rotational motion between the first gear and the second gear. As non-limiting examples, rather than engaged gears, pulleys with belts or chains may also be used. In addition, other embodiments may change the axes of rotation for the azimuth adjuster 250 and the elevation adjuster 260. One such exemplary embodiment is shown in FIGS. 4A and 4B.

FIGS. 4A and 4B show upper and lower views of another embodiment of an antenna aiming apparatus 200A with a single motor 240A and a bevel gear 262A as part of an elevation adjuster 260A. In the FIG. 4 embodiment, the elevation adjuster 260A includes the bevel gear 262A engaged with an intermediate gear 268, which is engaged with the first gear 252A. The bevel gear 262A is attached to the screw mechanism 270. The spindle 264 (also referred to herein as the elevation spindle) of the bevel gear 262A causes rotation of the lead screw 272A about a different axis from the embodiment in FIGS. 2 and 3. While referred to as a single bevel gear, those of ordinary skill in the art will recognize that there are actually two bevel gears, which are collectively referred to as bevel gear 262A, involved in the direction change. One bevel gear is fixed to the intermediate gear 268, and engages the other bevel gear fixed to the lead screw 272A. The bevel gear 262A, lead screw 272A, and lead nut 274A are attached to the platform 256A and thus rotate with the platform 256A and directional antenna 210A.

In operation, as the shaft of the motor 240A turns, it turns the platform 256A, and the directional antenna 210A about the azimuthal axis and the stationary first gear 252A. In addition, because the intermediate gear 268 is engaged with the first gear 252A, the intermediate gear 268 will also turn as it orbits about the first gear 252A. Rotation of the intermediate gear 268 causes rotation of the bevel gear 262A. As the bevel gear 262A turns, the elevation spindle 264A turns the lead screw 272A forcing the lead nut 274A out or in, which pushes or pulls on the linkage 275A, which pushes or pulls on the back side of the directional antenna 210A. Pushing and pulling on the backside of the directional antenna 210A causes the directional antenna 210A to pivot down or up about the elevational axis.

Thus, as with the embodiment of FIGS. 2 and 3, in the embodiment of FIGS. 4A and 4B, a complete turn of the directional antenna 210 about the azimuthal axis 280 causes a small pivot up or down of the directional antenna 210 about the elevational axis 290. In addition, springs allow the lead nut 274A to over travel and re-engage to prevent lock up at elevation extremes.

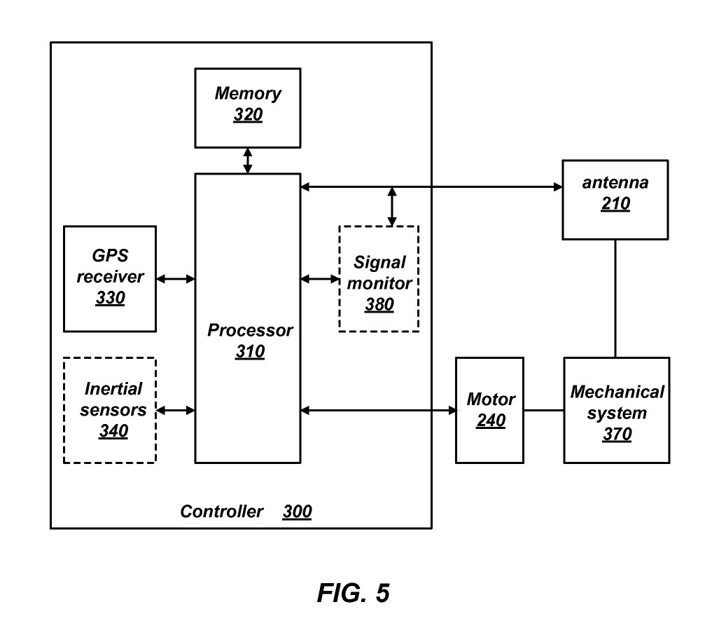

FIG. 5 is a simplified block diagram of an antenna aiming system. The system includes a controller 300, which sends and receives information from the directional antenna 210. The controller 300 also controls the motor 240, which drives a mechanical system 370, which points the directional antenna 210. The mechanical system 370 includes the azimuth adjuster 250, the elevation adjuster 260, and linkage 275, as shown in FIGS. 2-4.

With reference to FIGS. 1A, 1B, and 5, the controller 300 includes a processor 310, a memory 320, and a GPS receiver 330. In addition, the controller 300 may also include inertial sensors 340 and a received signal monitor 350. In operation, the GPS receiver 330 communicates GPS information (i.e., a GPS location or GPS coordinates) with the processor 310 to indicate a geographical location and elevation of the movable body 120. With the geographical location and elevation, along with a known location for the satellite 110, the processor 310 can determine the satellite-direction vector 112. When the movable body 120 is moving, repeated communication of GPS information enables the processor 310 to determine a direction of travel (i.e., the body-direction vector 152) for the movable body 120. With repeated GPS information, the controller 300 can develop and refine the body-direction vector 152 to generate new body-direction vectors 152 as the movable body 120 moves.

In some embodiments, a position may be determined without using GPS location. These embodiments may use an additional satellite at which the directional antenna can point. By pointing at two different satellites, at different locations, the processor can determine the geographic location based on the difference between the vectors to each of the two different satellites.

Using various combinations of the geographical location, the elevation, the satellite-direction vector 112, and the body-direction vector 152, the processor 310 can cause the motor to rotate to adjust both the elevation angle 160 and the azimuth angle 170 to point the directional antenna 210 at the satellite.

In some embodiments, inertial sensors 240 may be included to communicate inertial information to the processor 310. As non-limiting examples, the inertial sensors 240 may include accelerometers, gyroscopes, wheel motion from the vehicle, or other motion-sensing devices. The controller 300 can keep track of position, velocity, and direction of the movable body 120 by integrating the inertial information. Thus, the controller 300 can rotate the motor the desired amount to accurately point the directional antenna 210 based on GPS information, inertial information, or a combination thereof.

In some embodiments, a signal monitor 350 may be included. The signal monitor 350 may monitor the strength of the signal from the directional antenna 210. The processor 310 may use this signal strength information to determine how accurately the directional antenna 210 is pointed and form a closed-loop system to repeatedly make adjustments, through the motor 240 and mechanical system 370, to adjust the pointing direction of the directional antenna 210.

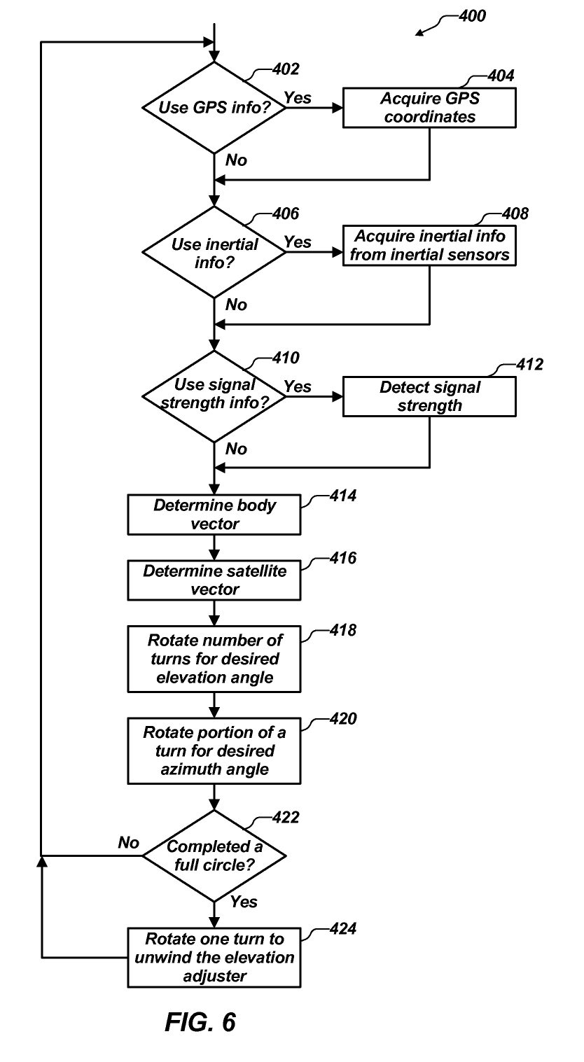

FIG. 6 is a simplified flow chart of a process 400 for aiming an antenna at a satellite when the antenna is attached to a movable body. Software processes illustrated and discussed herein are intended to illustrate exemplary processes that may be performed by the antenna aiming apparatus. Unless specified otherwise, the order in which the processes are described is not intended to be construed as a limitation. Furthermore, the processes may be implemented in any suitable hardware, software, firmware, or combinations thereof.

The process 400 performs a loop, which is described with reference to FIGS. 1A, 1B, 2, 5, and 6. Decision block 402 tests to see whether GPS information will be used on this pass through the loop. If so, operation block 404 acquires new GPS coordinates from the GPS receiver 330.

Decision block 406 tests to see whether inertial information will be used on this pass through the loop. If so, operation block 408 acquires new inertial information from the inertial sensors 340.

Decision block 410 tests to see whether signal strength information will be used on this pass through the loop. If so, operation block 412 determines the current signal strength.

Operation block 414 determines the current body-direction vector 152 based on the GPS information, inertial information, or a combination thereof. If no new information is available, a previous body-direction vector 152 may be used.

Operation block 414 determines the current satellite-direction vector 152 based on information in the controller about the current satellite position, GPS information, inertial information, or combinations thereof. If no new information is available, a previous satellite-direction vector 152 may be used.

If needed, operation block 418 causes the directional antenna 210 to rotate a number of full-turns to modify the elevation angle 160 to more accurately point at the satellite based on the elevational relationship 162 between the body-direction vector 152 and the satellite-direction vector 112. Due to the mechanical gain from the gears and linkages, one full rotation of the directional antenna 210 only causes a small change in the elevation angle, as is explained below. Thus, a number of turns may be needed to cause the desired elevation angle change.

Operation block 420 then causes the directional antenna 210 to rotate a partial-turn amount (i.e. less than or equal to a full-turn amount) to modify the azimuth angle 170 to more accurately point at the satellite based on the azimuthal relationship 172 between the body-direction vector 152 and the satellite-direction vector 112.

If signal strength is being used in the process, the full-turn amounts and partial-turn amounts created in operation blocks 418 and 420 may be determined by a closed-loop feedback algorithm based on current signal strength, previous signal strength, and anticipated future signal strength.

Operation block 422 tests to see if the movable body 120 has completed a full circle. For example, perhaps the vehicle 120 has gone completely around a block. If the vehicle completes full circles, the process may cause full turns to occur as the azimuth angle is corrected. These full turns cause a change in the elevation angle. If a full turn of the movable body 120 has occurred, operation block 424 “unwinds” the full turn by making a full-turn of the directional antenna 210 in the opposite direction to correct the elevation angle back to where it is desired.

The process 400 then repeats. While not shown, the directional antenna may be “zeroed” to an extreme angle of all the way up or all the way down. These extreme angles will be known by the process and can be used as initial conditions to determine the number of turns required to achieve the desired elevation angle.

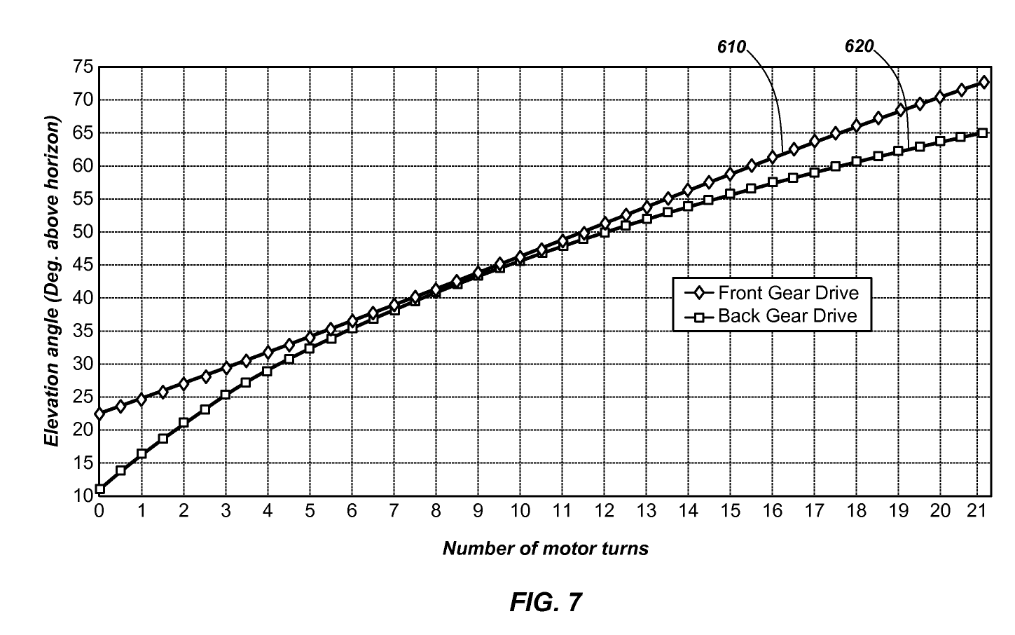

FIG. 7 is a graph of elevation angle relative to number of motor turns for various embodiments of the present invention. Curve 610 shows the elevation angle for the exemplary embodiment of FIGS. 2 and 3. The elevation angle may be changed from a low extreme of about 22 degrees up to a high extreme of about 72 degrees with about 2.5 degrees per full-turn.

Similarly, curve 620 shows the elevation angle for the exemplary embodiment of FIG. 4. The elevation angle may be changed from a low extreme of about 10 degrees up to a high extreme of about 65 degrees with about 2.5 degrees per full-turn.

Of course, as a person of ordinary skill in the art will recognize, the low and high extremes, as well as the number of degrees per full-turn may be modified in various embodiments of the invention by changing the mechanical system 370 (FIG. 5) by adjusting gear sizes and linkages.

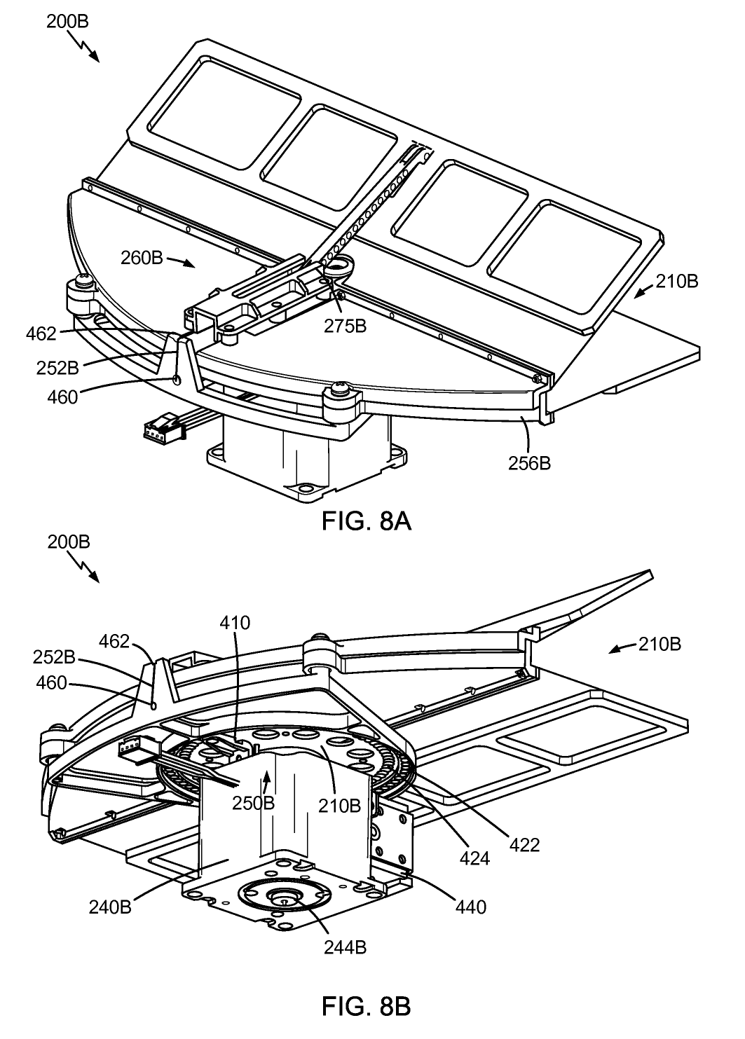

FIGS. 8A and 8B show upper and lower views of another embodiment of a directional antenna aperture 210B, an antenna aiming apparatus 200B with a single motor 240B and decoupled elevation and azimuth adjustments.

The azimuth adjuster 250B couples the motor 240B to the platform 256B via a clutch plate 420. The azimuth adjuster 250B includes a clutch arm 410 coupled to the motor spindle 244B. The clutch arm 410 holds a ball (not visible) against one of the holes in an inner ring of holes 424 in the clutch plate 420. The clutch arm 410 and ball may be held against one of the holes with a biasing agent, such as, for example a spring. Thus the azimuth adjuster 250B forms a detent between the clutch plate 420 and the motor spindle 244B.

In operation, as the motor 240B spins, the detent between the clutch arm 410 and the clutch plate 420 causes the clutch plate 420, platform 256B, and directional antenna aperture 210B to rotate.

The elevation adjuster 260B couples the motor 240B to the linkage 275B via a conveyor 252B. As a non-limiting example, the conveyor 252B is shown as a cable 252B. The cable 252B is wrapped around the motor spindle 244B and extends out through a hole 460 in a side of the platform 256B. The cable 252B wraps up through a notch 462 and attaches to an arm of the linkage 275B. The cable then returns to the motor spindle 244B to form a loop that is wrapped around the motor spindle 244B. Of course, other conveyors coupling the motor spindle 244B to the linkage 275B, such as combinations of belts, cables, and gears may be used in other embodiments of the present invention.

In operation, as the motor spindle 244B turns, the cable will move back and forth in such a way as to slide the linkage 275B back and forth. Sliding the linkage 275B back and forth causes the directional antenna aperture 210B and directional antenna (not shown) to pivot about the elevational axis.

The elevation adjuster 260B also includes a solenoid 440. When the solenoid 440 is activated, a plunger (not visible) engages in one of the holes in an outer ring of holes 422 in the clutch plate 420.

To adjust the elevation angle, the solenoid 440 is activated causing the plunger to engage with one of the holes in the outer ring of holes 422. This engagement prevents the clutch plate 420, platform 256B, and directional antenna (not shown) from rotating. Thus, as the motor turns, the cable will move back and forth, which slides the linkage back and forth, which pivots the directional antenna aperture 210B. While the elevation angle adjustment is happening, the platform 256B is held stationary by the activated solenoid 440. As a result, the torque of the motor 244B overcomes the detent of the clutch arm 410 holding the ball in one of the holes in the inner ring of holes 424 and the ball will slip to the next hole in the inner ring of holes 424. This slippage will occur to successive holes while the motor 240B is turning and the solenoid 440 is activated such that the clutch arm 410 rotates, but does not cause rotation of the clutch plate 420.

To adjust the azimuth angle, the solenoid 440 is deactivated causing the plunger to disengage from one of the holes in the outer ring of holes 422. Thus, the clutch plate 420 is not held stationary and the detent from the clutch arm 410 holding the ball against one of the holes in the inner ring of holes 424 will cause the clutch plate 420, platform 256, and directional antenna (not shown) to rotate about the azimuthal axis.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An antenna aiming apparatus, comprising:
a motor including a motor spindle;
a directional antenna;
an azimuth adjuster operably coupling the motor spindle and the directional antenna, the azimuth adjuster for rotating the directional antenna about an azimuthal axis responsive to a motor rotation;
an elevation adjuster operably coupled with the motor and for rotating responsive to the motor rotation; and
a screw mechanism operably coupled to the elevation adjuster and for modifying an elevation angle of the directional antenna responsive to a rotation of the elevation adjuster.

2. The antenna aiming apparatus of claim 1, wherein the elevation adjuster comprises:
a first gear fixedly coupled to a fixed portion of the antenna aiming apparatus; and
an elevation gear rotationally coupled with the screw mechanism and engaged with the first gear.

3. The antenna aiming apparatus of claim 1, wherein the elevation adjuster comprises an elevation spindle rotationally coupled with the screw mechanism and further comprising a conveyor operably coupled between a fixed portion of the antenna aiming apparatus and the elevation spindle for coupling a rotational motion between the directional antenna and the elevation spindle.

4. The antenna aiming apparatus of claim 3, wherein the conveyor is selected from the group consisting of a belt, a chain, and engaged gears.

5. The antenna aiming apparatus of claim 3, wherein the conveyor comprises: a first gear fixedly coupled to a fixed portion of the antenna aiming apparatus; and an elevation gear fixedly coupled to the elevation spindle and engaged with the first gear.

6. The antenna aiming apparatus of claim 3, wherein the conveyor comprises:
a first gear fixedly coupled to a fixed portion of the antenna aiming apparatus;
an intermediate gear including an intermediate spindle and engaged with the first gear; and
a bevel gear fixedly coupled to the elevation spindle and engaged with a bevel gear fixedly coupled to the intermediate gear.

7. The antenna aiming apparatus of claim 1, further comprising a linkage operably coupled between the screw mechanism and the directional antenna for pivotally adjusting the directional antenna about an elevational axis.

8. An antenna aiming apparatus, comprising:
a motor including a motor spindle;
a directional antenna fixedly attached to the motor spindle;
a first gear fixedly attached to the motor;
an elevation gear engaged with the first gear, the elevation gear including an elevation spindle; and
a screw mechanism coupled between the elevation spindle and the directional antenna.

9. The antenna aiming apparatus of claim 8, further comprising a linkage operably coupled between the screw mechanism and the directional antenna.

10. An antenna aiming apparatus, comprising:
a motor including a motor spindle;
a directional antenna;
an azimuth adjuster operably coupling the motor and the directional antenna and comprising:
a clutch plate fixedly attached to the directional antenna; and
a clutch arm fixedly attached to the motor spindle and for engaging with the clutch plate to rotate the directional antenna about an azimuthal axis as the motor spindle rotates;
an elevation adjuster operably coupling the motor and the directional antenna and comprising:
a solenoid for engaging with the clutch plate to inhibit rotation of the clutch plate; and
a conveyor operably coupled to the motor spindle to move the conveyor to and fro as the motor spindle rotates; and
a linkage fixedly coupled to the conveyor to pivot the directional antenna about an elevational axis as the conveyor moves to and fro.

11. The antenna aiming apparatus of claim 10, further comprising a detent mechanism for biasing the clutch arm against the clutch plate to inhibit slippage of the clutch arm relative to the clutch plate when the solenoid is not engaged with the clutch plate and to allow slippage of the clutch arm relative to the clutch plate when the solenoid is engaged with the clutch plate.

12. An antenna aiming apparatus, comprising:
a motor;
a directional antenna;
an azimuth adjuster operably coupling the motor and the directional antenna, the azimuth adjuster adapted to rotate the directional antenna about an azimuthal axis responsive to a motor rotation;
an elevation adjuster operably coupled with the motor and for rotating responsive to the motor rotation; and
a screw mechanism operably coupling the elevation adjuster and the directional antenna and for modifying an elevation angle of the directional antenna responsive to a rotation of the motor; and
a controller operably coupled to the motor for determining a motor rotation amount.

13. The antenna aiming apparatus of claim 12, wherein the controller further comprises a GPS receiver for determining GPS coordinates and the controller is further for:
determining an elevation and a body-direction vector responsive to the GPS coordinates; and
determining the motor rotation amount responsive to the body-direction vector.

14. The antenna aiming apparatus of claim 12, wherein the controller further comprises an inertial sensor for determining inertial information about a movable body to which the antenna aiming apparatus is attached and the controller is further for:
determining an body-direction vector responsive to the inertial information; and
determining the motor rotation amount responsive to the body-direction vector.

15. The antenna aiming apparatus of claim 12, wherein the controller further comprises a signal monitor for detecting a signal on the antenna and the controller is further for:
determining a strength of the signal; and
determining the motor rotation amount responsive to the strength of the signal.

16. A method, comprising:
determining a body-direction vector of a movable body with a satellite-tracking antenna attached thereto;
adjusting an elevation angle of the satellite-tracking antenna responsive to an elevational relationship between the body-direction vector and a satellite-direction vector by rotating a motor to achieve full-turn amounts of the satellite-tracking antenna; and
adjusting an azimuth angle of the satellite-tracking antenna responsive to an azimuthal relationship between the body-direction vector and the satellite-direction vector by rotating the motor to achieve partial-turn amounts of the satellite-tracking antenna.

17. The method of claim 16, wherein determining the body-direction vector comprises:
periodically determining GPS locations of the movable body; and
establishing the body-direction vector from at least two of the GPS locations.

18. The method of claim 16, wherein determining the body-direction vector comprises acquiring inertial information from inertial sensors attached to the movable body.

19. The method of claim 16, further comprising adjusting the elevation angle of the satellite-tracking antenna responsive to a determination that the movable body has performed substantially a full rotation by rotating the motor to achieve one full-turn amount of the satellite-tracking antenna.

20. A method, comprising:
performing a signal strength analysis for a satellite-tracking antenna attached to a movable body;
adjusting an elevation angle of the satellite-tracking antenna responsive to the signal strength analysis by rotating a motor to achieve full-turn amounts of the satellite-tracking antenna;
adjusting an azimuth angle of the satellite-tracking antenna responsive to the signal strength analysis by rotating the motor to achieve partial-turn amounts of the satellite-tracking antenna; and
periodically repeating the performing the signal strength analysis, the adjusting the elevation angle and the adjusting the azimuth angle to enhance a signal strength for the satellite-tracking antenna.

21. The method of claim 20, further comprising:
determining a body-direction vector of the movable body;
adjusting the elevation angle of the satellite-tracking antenna responsive to an elevational relationship between the body-direction vector and a satellite-direction vector by rotating the motor to achieve the full-turn amounts of the satellite-tracking antenna; and
adjusting the azimuth angle of the satellite-tracking antenna responsive to an azimuthal relationship between the body-direction vector and the satellite-direction vector to achieve the partial-turn amounts of the satellite-tracking antenna.

22. The method of claim 21, wherein determining the body-direction vector comprises:
periodically determining GPS locations of the movable body; and
establishing the body-direction vector from at least two of the GPS locations.

23. The method of claim 21, wherein determining the body-direction vector comprises acquiring inertial information from inertial sensors attached to the movable body.

24. A method, comprising:
periodically determining GPS locations of a movable body with a satellite-tracking antenna attached thereto;
determining an elevation of the movable body from at least one of the GPS locations;
determining a body-direction vector of the movable body from at least two of the GPS locations;
adjusting an elevation angle of the satellite-tracking antenna responsive to the elevation by rotating a motor to achieve full-turn amounts of the satellite-tracking antenna; and
adjusting an azimuth angle of the satellite-tracking antenna responsive to an azimuthal relationship between the body-direction vector and the satellite-direction vector to by rotating the motor to achieve partial-turn amounts of the satellite-tracking antenna.

25. A system, comprising:
means for determining a body-direction vector of a movable body with a satellite-tracking antenna attached thereto; and
means for coupling adjustments to an elevation angle and adjustments to an azimuth angle of a satellite-tracking antenna with a same motor rotation responsive to a relationship between the body-direction vector and a satellite-direction vector, wherein the satellite-tracking antenna rotates responsive to the motor, and wherein:
full-turn amounts of the satellite-tracking antenna adjust the elevation angle; and
partial-turn amounts of the satellite-tracking antenna adjust the azimuth angle.

26. The system of claim 25, wherein the means for determining the body-direction vector comprises means for acquiring inertial information of the movable body.

27. The system of claim 25, wherein the means for determining the body-direction vector comprises:
means for periodically determining GPS locations of the movable body; and
means for establishing the body-direction vector from at least two of the GPS locations.

28. The system of claim 25, further comprising means for adjusting the elevation angle of the satellite-tracking antenna responsive to a means for determining that the movable body has performed substantially a full rotation by rotating the motor to achieve one full-turn amount of the satellite-tracking antenna.

29. The system of claim 25, further comprising:
means for performing a signal strength analysis of the satellite-tracking antenna;
means for rotating the motor at least one additional full-turn amount to adjust the elevation angle of the satellite-tracking antenna responsive to the signal strength analysis; and
means for rotating the motor an additional partial-turn amount to adjust the azimuth angle of the satellite-tracking antenna responsive to the signal strength analysis.
